(19) United States
(12) Patent Application Publication
(10) Pub. No.: US 2006/0214383 A1
(43) Pub. Date: Sep. 28, 2006

(54) Collapsible shopping cart

(76) Inventor: Carol Yoh, Manhasset, NY (US)

Correspondence Address: WILLIAM COLLARD;COLLARD & ROE, P.C., 1077 NORTHERN BOULEVARD, ROSLYN, NY, 11576, US

(21) Appl. No.: 11/087,956

(22) Filed: Mar. 23, 2005

(51) Int. Cl. B62B 3/00

(52) U.S. Cl. 280/47.34

(57) ABSTRACT

A collapsible shopping cart which can include a basket comprising a bottom surface, a front surface, a back surface wherein the bottom surface is rotatably coupled to the back surface, and the front surface is rotatably coupled to the bottom surface. There are also side surfaces that are rotatably coupled to the front surface and rotatably coupled to the back surface. The second side surface is rotatably coupled to the front surface and the back surface so that the front surface can be collapsed into the back surface. This device can also include a plurality of wheels and a gear system coupled to the basket for moving at least one of the wheels from a first position to a second position to allow the shopping cart to be collapsed into a closed form.

### BACKGROUND OF THE INVENTION

### Field of the Invention

The present invention relates to a collapsible shopping cart. Other collapsible shopping carts are known in the art. For example, U.S. Pat. No. 3,191,956 to Rizzuto issued on Jun. 29, 1965; U.S. Pat. No. 5,984,327 to Hsieh et al. issued on Nov. 16, 1999; U.S. Pat. No. 4,659,096 to Leimgruber issued on Mar. 6, 1985; U.S. Pat. No. 4,274,644, to Taylor issued on Jun. 23, 1981; U.S. Pat. No. 5,403,022 to Snider issued on Apr. 4, 1995 and U.S. Patent Application Publication No. 2002/0096861 to Tsai published on Jul. 25, 2002 wherein the disclosures of these references are hereby incorporated herein by reference.

### SUMMARY OF THE INVENTION

The invention relates to a collapsible shopping cart that has a gearing mechanism that allows it to collapse into a compacted state.

For example, one embodiment can relate to a collapsible shopping cart which can include a basket comprising a bottom, a front, and a back. The bottom, front and back can be formed by a plurality of substantially parallel spaced wires forming an enclosing surface or, for example, a frame. The bottom is rotatably coupled to the back, and the front is rotatably coupled to the bottom. There are also side surfaces that are rotatably coupled to the front and rotatably coupled to the back, wherein a second side is rotatably coupled to the front and the back so that the front can be collapsed into the back. This device can also include a plurality of wheels and a gear system coupled to the basket for moving at least one of the wheels from a first position to a second position to allow the shopping cart to be collapsed into a closed form.

In another embodiment, the device can relate to a collapsible shopping cart that includes a basket such that when the basket is in use it comprises a bottom surface, a front surface rotatably coupled to the bottom, and a back surface rotatably coupled to the bottom surface. There can also be least two sides rotatably coupled to the front and the back. A plurality of wheels can be coupled to the basket as well. This embodiment can include a translational gear system which includes a first gear and a second gear that mesh together so that when the front surface or side is moved relative to the back surface or side, the first gear rotates and meshes with the second gear so that the second gear rotates. In this case, the first gear rotates about a first axis and the second gear rotates about a second axis wherein the first axis and the second axis are offset from each other by approximately 90°. With this design, there are brackets coupled to the gears with a first bracket coupled to the first gear and a second bracket coupled to the second gear. In this case, one of the wheels is coupled to the second bracket such that when the first gear rotates, the second gear rotates correspondingly, causing the second bracket to rotate and causing said at least one of the wheels to move from a first orientation to a second orientation that is approximately 90° offset from the first orientation.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a front end view of a collapsible shopping cart;

FIG. 2 is a side view of a collapsible shopping cart;

FIG. 3 is a side view of a collapsible shopping cart being folded up;

FIG. 4 is a close up view of a gearing mechanism of the collapsible shopping cart as shown in FIG. 3;

FIG. 5 is a side view of a shopping cart in its collapsed position; and

FIG. 6 is a perspective close up view of a translational gearing system.

### DETAILED DESCRIPTION OF PREFERRED EMBODIMENTS

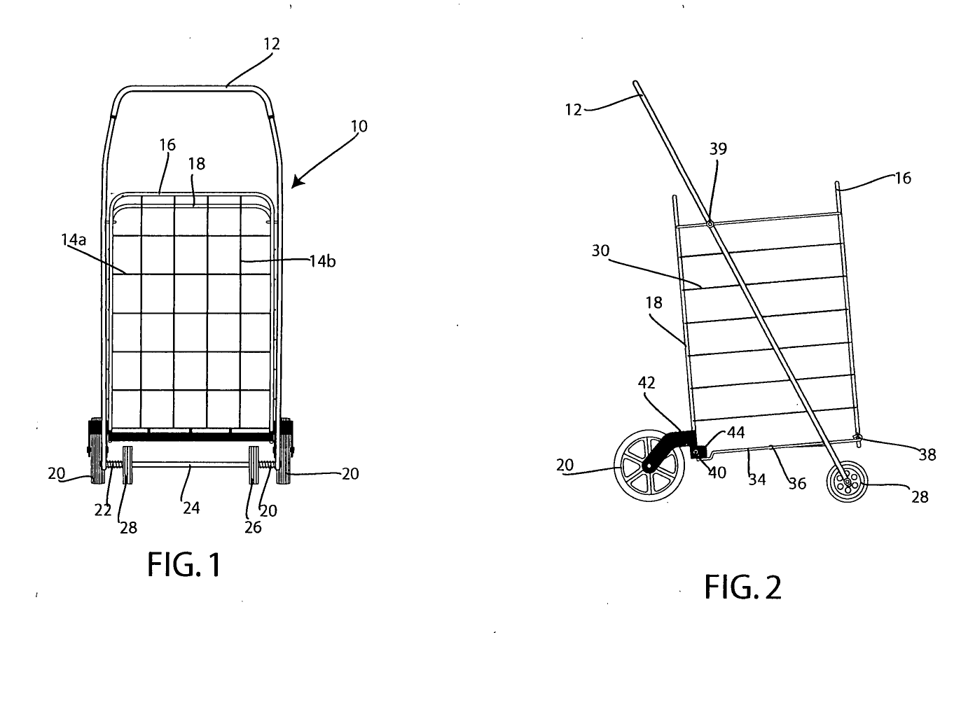

Turning now in detail to the drawings, FIG. 1 is a front end view of a collapsible shopping cart 10. In this case, the collapsible shopping cart 10 can include a handle 12, a front side or surface 16 and a back side or surface 18. Front 16 and back 18 can include a plurality of vertically and horizontally extending bars 14a and 14b which are spaced apart from each other in a substantially parallel manner. These vertically and horizontally extending bars can be used to keep articles within a cart basket.

This device can also include a set of back wheels 20A and 20B and also a set of front wheels 26A and 26B, wherein these front wheels can be associated with a spring 22.

FIG. 2 shows a side view of the device shown in FIG. 1 wherein this side view shows a plurality of side bars 30 extending from front or first side or surface 16 to back or second side or surface 18. There is also a hinge 39 which is used to connect handle 12 with handle side bars 30 so that handle 12 can rotate about side bars 30. A connecting bar 32 can be used to connect handle 12 with hinge 36 so that handle 12 can be rotated up and into a closed position (SEE FIG. 4). In this case, front side or surface 16 is rotatably connected to a bottom bar 34, via a hinge connection 38.

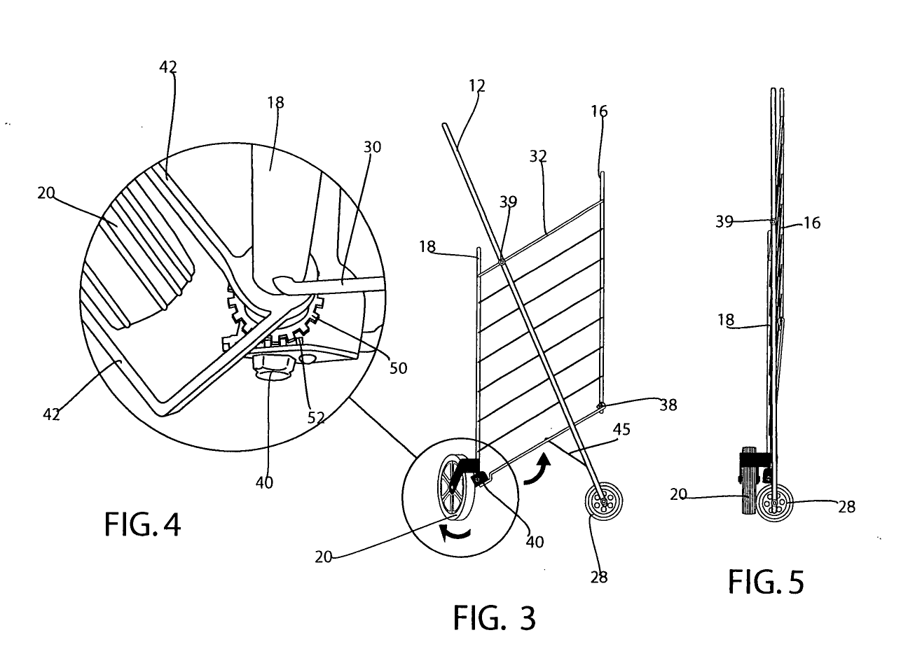

FIG. 3 shows the start of a collapsing movement of the device wherein front side or surface 16 is pushed up or folded up around hinge 38, so that front side or surface 16 moves rotationally up and towards back side or surface 18. Hinge 38 facilitates this movement along with the other hinge or rotatable connections between side bars 30 and front side 16. Side bars 30 are also rotatably coupled at an opposite end to second or back side or surface 18. These connections allow side bars 30 to have rotatable connections at both ends so that front or first surface 16 can move in position relative to back or second side or surface 18.

In addition, while front side 16 is being moved in to a collapsed position adjacent to second or back side 18, handle 12 can rotate relative to side bars 30, in particular, relative to a top side bar 30a on hinge 39. Handle 12 is also connected to a support bar 45 which forms a connection between support bar 45 and a bottom side bar 30b. At a first end, support bar 45 is rotatably coupled to bottom side bar 30a, while at a second end, support bar 45 is rotatably coupled to handle 12. Thus, as handle 12 rotates, support bar 45 can rotate about its connection to bottom side bar 30b so that handle 12 can rotate while wheel 28 moves back towards wheel 20.

Bottom side bar 30b can have a bend which can form a receiving area for a bracket 40. Bracket 40 is rotatably coupled to back side 18 via a hinge 41, which allows bracket 40 to rotate as bottom side bar 30b rotates. In this case, as shown in FIG. 6, bottom side bar 30b can be coupled to back or side 18 via a rotatable connection or a hinge 43. In this case, as bottom side bar 30b rotates up, it pushes up on bracket 40 which causes bracket 40 to rotate up, wherein as shown, for example, in FIG. 3, bracket 40 rotates in a counter-clockwise manner. Bottom side bar 30b is in the form of a bent bar which has a curve forming a guide receiving area or a seating 31 for bracket 40. Guide 31 keeps bracket 40 in place as bottom side bar 30b rotates. In this view, back side 18 is coupled to a side 42 which is used to stabilize and form a connection to a back wheel 20. Back wheel 20 can be, for example, larger than front wheel 28.

FIG. 4 shows a close up, top perspective view of a circled region shown in FIG. 3. In this view, there is a first gear 51 which is coupled to bracket 40 and a second gear 52 which is coupled to bracket 42. As bracket 40 rotates up as caused by the rotational movement of bottom side bar 18b, it causes gear 51 to rotate with this bracket 40. Gear 51 which is shown, for example, in FIG. 4 is positioned so that it can rotate about a first axis which can be a substantially horizontal axis. As gear 51 rotates, it meshes with gear 52, which as shown by example, can rotate about a second axis which can be a substantially vertical axis. This gear connection therefore provides a translation from a rotational movement in a first direction to a rotational movement in a direction offset by approximately 90°.

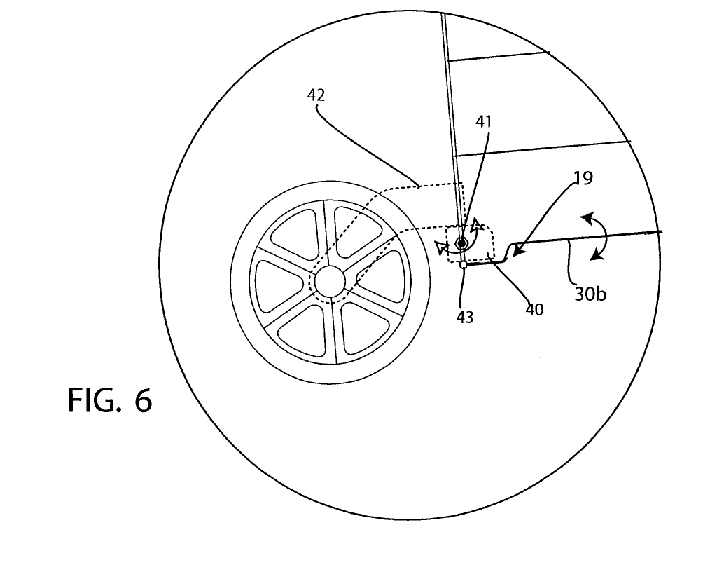

This translational movement causes wheels and bracket 42 to fold in behind the cart so that, as shown in FIG. 5, the entire device can be collapsed into one simple compact cart.

FIG. 5 shows this compact position of the cart 10, wherein in this position, the cart can be placed into storage and then subsequently moved or packed away for shipping. With the design of this cart, the entire cart can be shipped easily and then easily assembled as well. With this design, the compact cart shown in FIG. 5 can also be unfurled or unbundled so that this compacting movement can be undone in a reverse process so that front side 16 can be moved away from back side 18 in a clockwise manner wherein in this movement, bottom side bar 30b rotates in a clockwise manner causing bracket 40 to also move in a clockwise manner, which causes bracket 42 and gear 52 to rotate out, causing wheel 20 to rotate out from back side 18.

Accordingly, while a few embodiments of the present invention have been shown and described, it is to be understood that many changes and modifications may be made thereunto without departing from the spirit and scope of the invention as defined in the appended claims.

What is claimed is:

1. A collapsible shopping cart comprising:
a) a basket such that when said basket is in use it comprises:
i) at least one bottom side;
ii) at least one front side;
iii) at least one back side;
iv) wherein said at least one bottom side is rotatably coupled to said at least one back side, and said at least one front side is rotatably coupled to said at least one bottom side; and
v) at least two side surfaces comprising at least one first side surface and at least one second side surface, wherein said at least one first side surface is rotatably coupled to said at least one front side and rotatably coupled to said at least one back side, and wherein said second side surface is rotatably coupled to said at least one front side and said at least one back side so that said at least one front side can be collapsed onto a position adjacent said at least one back side; and
b) a plurality of wheels; and
c) a gear system coupled to said basket for moving at least one of said plurality of wheels from a first position to a second position to allow the shopping cart to be collapsed into a closed form.

2. The device as in claim 1, wherein said gear system comprises a translational gear system for causing at least one wheel of said plurality of wheels to rotate from a first position to a second position as said at least one front side is being moved relative to said at least one back side.

3. The device as in claim 2, wherein said translational gear system includes a first gear and a second gear that mesh together so that when said front side is moved relative to said back side, said first gear rotates, and meshes with said second gear so that said second gear rotates.

4. The device as in claim 3, wherein said first gear rotates about a first axis and said second gear rotates about a second axis wherein said first axis and said second axis are offset from each other by approximately 90°.

5. The device as in claim 4, further comprising a first bracket coupled to said first gear, and disposed adjacent to said bottom side, said first bracket being rotatably coupled to said back side, and a second bracket that is coupled to said second gear and rotatably coupled to said back side, wherein when said front side is moved relative to said back side, said bottom side moves with said front side causing said first bracket to rotate about an axis extending from said back side, causing said first gear to rotate about its axis which results in said second gear rotating in response to said first gear.

6. The device as in claim 5, further comprising a handle, rotatably coupled to said at least one first side surface, wherein said handle has a first end and a second end.

7. The device as in claim 6, further comprising a plurality of additional wheels, wherein said plurality of additional wheels are coupled to said second end of said handle.

8. The device as in claim 1, wherein said at least two side surfaces and said at least one bottom side are at least in part formed by a bottom side bar.

9. The device as in claim 8, wherein said bottom side bar is in the form of a bent bar, having a receiving area for receiving said first bracket.

10. The device as in claim 9, further comprising at least one support bar which has a first end coupled to said bottom side bar, and a second end coupled to said handle.

11. A collapsible shopping cart comprising:
a) a basket such that when said basket is in use it comprises:
i) at least one bottom side;
ii) at least one front side;
iii) at least one back side;
iv) wherein said at least one bottom side is rotatably coupled to said at least one back side, and said at least one front rack is rotatably coupled to said at least one bottom side; and
v) at least two side surfaces comprising at least one first side surface and at least one second side surface wherein said at least one first side surface is rotatably coupled to said at least one front side and rotatably coupled to said at least one back side, and wherein said second side is rotatably coupled to said at least one front side and said at least one back side so that said at least one front side can be collapsed into said at least one back side;
b) a plurality of wheels;
c) a translational gear system which includes a first gear and a second gear, that mesh together so that when said front side is moved relative to said back side, said first gear rotates and meshes with said second gear so that said second gear rotates, wherein said first gear rotates about a first axis and said second gear rotates about a second axis wherein said first axis and said second axis are offset from each other by approximately 90°;
d) a first bracket coupled to said first gear, and disposed adjacent to said bottom side, said first bracket being rotatably coupled to said back side, and a second bracket that is coupled to said second gear and rotatably coupled to said back side wherein when said front side is moved relative to said back side, said bottom side moves with said front side causing said first bracket to rotate about an axis on said back side, causing said first gear to rotate about its axis which results in said second gear rotating in response to said first gear; and
wherein at least one of said plurality of wheels is coupled to said second bracket such that when said first gear rotates, said second gear correspondingly rotates causing said second bracket to rotate causing said at least one of said plurality of wheels to move from a first orientation to a second orientation that is approximately 90° offset from said first orientation.

12. A collapsible shopping cart comprising:
a) a basket such that when said basket is in use it comprises:
i) at least one bottom side;
ii) at least one front side;
iii) at least one back side;
iv) wherein said at least one bottom side is rotatably coupled to said at least one back side, and said at least one front side is rotatably coupled to said at least one bottom side;
v) at least two side surfaces comprising at least one first side surface and at least one second side surface, wherein said at least one first side surface is rotatably coupled to said at least one front side and rotatably coupled to said at least one back side, and wherein said second side surface is rotatably coupled to said at least one front side and said at least one back side so that said at least one front side can be collapsed into said at least one back side;
b) a plurality of wheels; and
c) a translational gear means for rotating at least one of said plurality of wheels from a first position to a second position when said at least one front side is moved from a first position relative to said back side to a second position relative to said back side.
